(19) United States
(12) Patent Application Publication
(10) Pub. No.: US 2026/0358776 A1
(43) Pub. Date: Nov. 12, 2026

(54) RECOGNITION-DIRECTED ADAPTIVE PHASE-LOCKED ENERGY -HARVESTING SYSTEM CONTROLLER

(71) Applicant: Jonathan Washburn, Austin, TX (US)

(72) Inventor: Jonathan Washburn, Austin, TX (US)

(21) Appl. No.: 19/674,933

(22) Filed: May 12, 2026

Related U.S. Application Data
(60) Provisional application No. 63/804,603, filed on May 12, 2025.

(51) Int. Cl. G05B 17/02; H02N 11/00

(52) U.S. Cl. CPC G05B 17/02; H02N 11/002

(57) ABSTRACT

A recognition-directed adaptive phase-locked energy-harvesting system controller is disclosed for use with energy-harvesting transducers exhibiting discontinuous, mode-dependent, or resonance-dependent operating behavior. The controller includes a recognition engine configured to receive real-time electrical signals, determine measured power, form normalized power ratios relative to candidate modal-node template powers, and evaluate a J-cost function J(x)=½(x+1/x)−1 to identify a recognized modal node. A phase-locked loop adjusts one or more switching power-stage parameters to lock harvested operation to the recognized modal node. In preferred embodiments, node recognition uses a threshold phi\hat{ }−5, harvested energy is transferred only in integer multiples of E_coh=phi\hat{ }-5, and one or more of classification timing, gate-drive timing, and transfer release are synchronized to 8tau0 boundaries. In further embodiments, the controller manages multiple heterogeneous transducer channels.

### CROSS-REFERENCE TO RELATED APPLICATIONS

This application claims priority to U.S. Provisional Patent Application No. 63/804,603, filed May 12, 2025, the entirety of which is incorporated herein by reference.

### BACKGROUND OF THE INVENTION

The present disclosure relates generally to power-management electronics and, more particularly, to controllers for energy-harvesting systems having transducers with discontinuous, mode-dependent, or resonance-dependent operating behavior. More particularly, the disclosure relates to recognition-directed adaptive phase-locked controllers that classify real-time transducer operation into discrete modal nodes and control a switched power stage based on a recognized node. In preferred embodiments, the disclosure further relates to quantized energy transfer and synchronization of control activity to a ledger-compatible cadence.

Traditional maximum-power-point tracking (MPPT) methods generally assume that a source exhibits a relatively smooth and substantially monotonic power-versus-voltage relationship over the relevant operating range. That assumption is often acceptable for conventional photovoltaic panels and other sources whose operating optimum can be reached by continuous hill-climbing or perturb-and-observe techniques. However, that assumption is poorly matched to many modern energy-harvesting transducers whose optimal operating points shift discontinuously among discrete operating modes, resonance states, or narrow rectification windows.

A variety of transducer classes exhibit such modal or discontinuous behavior. By way of example, spin-Seebeck laminates can exhibit discrete thermal-magnon modes, rectenna tiles can exhibit narrow rectification peaks, piezoelectric or magnetostrictive harvesters can exhibit discrete mechanical resonance modes, and near-field thermophotovoltaic (NF-TPV) devices can exhibit spectral channels associated with cavity modes. In such systems, operation away from the correct mode can materially reduce harvested power, including during transients when the optimal operating point shifts from one mode to another.

Conventional approaches suffer from multiple limitations in this context. First, continuous MPPT techniques are poorly suited to transducers whose optimum does not move smoothly along a continuous curve but instead jumps among discrete modal nodes. Second, fixed lookup tables can become inaccurate when transducer behavior changes due to temperature, vibration magnitude, emitter condition, load state, aging, or other operating variables. Third, hill-climbing approaches can incur substantial transient loss while searching through suboptimal operating points. Fourth, many prior controllers are designed for a single source type rather than a heterogeneous set of different modal transducers. Fifth, prior-art systems generally do not perform real-time modal classification of the transducer state and then lock a switching power stage to the recognized node. Sixth, prior-art systems typically extract energy in arbitrary continuous amounts rather than according to the disclosed transfer discipline. Seventh, prior-art controllers typically rely on heuristic cost functions, heuristic confidence scores, or generic optimization losses rather than a physically grounded cost metric.

Accordingly, a need exists for an improved controller that can identify a discrete modal operating point in real time and retune a power stage to that operating point rapidly and robustly across heterogeneous energy-harvesting transducers. In preferred embodiments, a further need exists for a controller that constrains transfer magnitude and timing according to a coherence quantum and a ledger-compatible cadence.

### SUMMARY OF THE INVENTION

The present disclosure provides a recognition-directed adaptive phase-locked energy-harvesting system controller for use with energy-harvesting transducers that exhibit discontinuous, mode-dependent, resonance-dependent, or otherwise discrete optimal operating behavior. In one aspect, the controller acquires real-time transducer waveforms, computes normalized power ratios relative to candidate modal-node templates, evaluates a J-cost function J(x)=½(x+1/x)−1 for the candidate modal nodes, identifies a modal node according to the resulting J-cost values, and retunes a switching power stage to lock harvested operation to the recognized node. The core inventive mechanism is therefore a recognize-then-lock controller architecture in which discrete modal recognition precedes and directs closed-loop retuning. This architecture is distinct from continuous maximum-power-point search, from generic adaptive control, and from controllers that regulate output without first classifying the transducer into a discrete modal operating node.

In another aspect, the disclosure provides a method of operating an energy-harvesting system, the method including sensing voltage and current associated with one or more transducers, determining instantaneous power, forming normalized power ratios relative to respective candidate node template powers, evaluating J-cost for the candidate nodes, selecting a recognized node according to the evaluated J-cost values, and adjusting one or more switching power-stage parameters to phase-lock the system to the recognized node. The method can be repeated continuously or iteratively so that the controller tracks modal shifts during changing source, environmental, or load conditions.

In preferred embodiments, the J-cost function J(x)=½(x+1/x)−1 is used as a physically grounded recognition metric rather than a heuristic loss or confidence score. In preferred embodiments, the threshold phi\hat{ }−5 is not arbitrary and is used as J_threshold for node recognition. In preferred embodiments, if multiple candidate modal nodes satisfy the threshold criterion, the controller selects the node having minimum J-cost. In preferred embodiments, a recognized-node decision is confirmed only after two consecutive qualifying samples aligned to 8tau0 boundaries.

In preferred embodiments, the controller includes a phase-locked loop configured to adjust one or more control parameters of a switching power stage, including duty cycle, switching phase, source impedance, gate timing, or combinations thereof, so that harvested operation is locked to the recognized node. In preferred embodiments, phase-locked control coefficients are derived from phi-ratios, including K_p=1/phi, K_i=phi\hat{ }2, and K_d=phi\hat{ }−5, and these coefficients are not arbitrary tuning constants in the disclosed architecture.

In preferred embodiments, the controller further includes an E_coh-locked transfer stage. In such embodiments, E_coh=phi\hat{ }−5 serves as a coherence quantum, and harvested energy is transferred only in integer multiples of E_coh. In preferred embodiments, the transfer stage includes an energy accumulator, an integer threshold detector, a gated transfer switch, and a remainder recirculation path. In preferred embodiments, the least significant bit of the accumulator corresponds to E_coh, transfer is enabled when accumulated energy reaches or exceeds N×E_coh, and any remainder below the next integer multiple is retained for a later cycle. In preferred embodiments, such transfer maintains ledger neutrality, represented in the disclosed architecture by DeltaC=N×E_coh−N×E_coh=0.

In preferred embodiments, the controller further uses an eight-tick cadence for timing alignment. In the disclosed RS-native architecture, the 8-tick period is the unique minimal ledger-compatible cycle. In preferred embodiments, classification cadence, gate-drive edge timing, and transfer release timing are synchronized to integer multiples of 8tau0. In preferred embodiments, gate-drive edges are snapped according to t_edge=round(t_PLL/(8tau0))×8tau0.

In certain embodiments, the controller manages multiple heterogeneous energy-harvesting channels. The channels can be associated with different transducer classes, including piezoelectric, magnetostrictive, spin-Seebeck, near-field thermophotovoltaic, rectenna, thermoelectric, and other modal transducers. In preferred embodiments, each channel is independently sensed, classified, and retuned. In preferred embodiments, source impedance is programmable on a phi-ladder according to Z_n=Z_0×phi\hat{ }n for integer n, and fine control within a selected rung is provided by pulse-width modulation or an equivalent control mechanism.

In demonstrated embodiments, the disclosed controller architecture is implemented using a recognition engine, a digital adaptive phase-locked loop, a multi-input synchronous buck-boost array, an E_coh-locked transfer stage, and telemetry and failsafe logic. Reported example results include recognition latency of approximately 4 microseconds, settling time of approximately 13 milliseconds, conversion efficiency of approximately 96 percent at 4.8 W aggregate input, improved transient harvesting relative to legacy MPPT, 120-hour burn-in without node misclassification, and compliance with CISPR-25 class 3 emissions requirements with stated margin. Such results provide validation support for disclosed embodiments and are not required limitations unless expressly recited.

In certain sections of the specification, the disclosure may identify machine-checked support for the J-cost kernel, coherence exponent, eight-tick uniqueness, ledger neutrality, and related propositions by reference to corresponding Lean modules. Such references are included as technical support and credibility anchors for disclosed embodiments and should not be understood as replacing the operational, structural, and make-and-use disclosure provided herein.

### BRIEF DESCRIPTION OF THE DRAWINGS

FIG. 1 is a block diagram of an overall recognition-directed adaptive phase-locked energy-harvesting system controller architecture showing a controller, a recognition engine, an adaptive phase-locked loop, a multi-input power stage, an E_coh-locked transfer stage, a telemetry and failsafe subsystem, one or more transducer inputs, and a regulated output path.

FIG. 2 is a flow diagram illustrating an operational workflow for modal recognition and lock control, including sensing, preprocessing, template retrieval, normalized power-ratio computation, J-cost evaluation, thresholding and ranking, node selection, phase-locked retuning, transfer gating, and telemetry or fault handling.

FIG. 3 is a block diagram of a recognition engine pipeline showing a sensor input interface, a power calculator, a feature-vector generator, a modal template memory, a ratio engine, a J-cost compute pipeline, a threshold comparator, an argmin selector, persistence logic, and a node output register.

FIG. 4 is a diagram illustrating modal-template and J-cost evaluation relationships, including a candidate node set, corresponding template powers, measured power, normalized power-ratio outputs, computed J-cost values, a threshold level, a qualifying node subset, and a selected winning node.

FIG. 5 is a block diagram of an adaptive phase-locked loop and timing-alignment architecture showing a recognized-node input, a phase detector, a loop filter, a control-law block, a timing source, an edge-alignment stage, and corresponding switch-drive, duty-cycle, and impedance-selection outputs.

FIG. 6 is a block diagram of a multi-input power stage with phi-ladder impedance control, including multiple transducer channel inputs, a synchronous converter stage, switching devices, an energy storage element, a sense path, an impedance network, a phi-ladder rung selector, a fine-control block, and a channel output combiner.

FIG. 7 is a block diagram of an E_coh-locked transfer stage showing a channel energy input, an accumulator, an accumulator least-significant-bit reference, an integer threshold detector, transfer-enable logic, a transfer switch, an output-bus coupling, a remainder recirculation path, and a transfer counter.

FIG. 8 is a timing diagram showing eight-tick synchronization, including a macro switching period, 8tau0 slot boundaries, raw PLL edge timing, snapped gate-edge timing, classification sample points, a consecutive-qualifier window, and a transfer-release boundary.

FIG. 9 is a block diagram of a heterogeneous multi-transducer system embodiment showing multiple different transducer types coupled to a common controller, an output bus, a storage device, a load device, and an optional powered module.

FIG. 10 is a block diagram of a telemetry, watchdog, and failsafe subsystem showing a status-input aggregator, node and J-cost registers, a duty-and-impedance status block, a transfer-count register, an efficiency estimator, a telemetry formatter, watchdog logic, a fault detector, and a safe-mode controller.

FIG. 11 is a diagram showing performance comparison and transient response, including an RD-PLL output trace, an MPPT output trace, a settling-time interval, overshoot comparison, transient energy-loss comparison, steady-state efficiency summary, phase-accuracy summary, and latency summary.

FIG. 12 is a diagram showing a validation and measured-results summary, including a mixed-source bench configuration, per-channel J-cost results, burn-in summary, EMC summary, timing-alignment summary, transfer-quantization summary, and implementation-support summary.

### DETAILED DESCRIPTION OF THE INVENTION

Reference will now be made in detail to illustrative embodiments of the disclosed subject matter. The following detailed description is provided to enable a person of ordinary skill in the art to make and use the disclosed controller architecture, and to support a range of claim scopes extending from the core recognize-then-lock control mechanism to narrower embodiments including quantized transfer, eight-tick synchronization, phi-ladder impedance control, and specific hardware implementations. The disclosed embodiments are illustrative rather than limiting except where a feature is expressly described as required by the stated architecture or by the preferred RS-native implementation.

In the disclosed architecture, the core inventive mechanism is a controller that recognizes a discrete modal operating node of an energy-harvesting transducer by evaluating J-cost over normalized power ratios and then retunes a switching power stage by a phase-locked control loop to lock operation to the recognized node. This recognize-then-lock mechanism is distinct from continuous maximum-power-point search, from perturb-and-observe control, from hill-climbing control, and from generic adaptive control systems that do not first classify the transducer into a discrete modal node. In preferred embodiments, the disclosed architecture further constrains energy transfer to integer multiples of E_coh=phi\hat{ }−5 and constrains classification timing, gate-drive timing, and transfer release timing to 8tau0 boundaries or permitted 8tau0-aligned events. The identity of the invention is therefore the recognition-directed controller architecture and its node-directed retuning logic, not merely the use of a switched converter or a general-purpose closed-loop regulator.

As used herein, a “modal node” refers to a discrete operating state, resonance-associated state, rectification window, spectral operating state, or other identifiable operating condition of an energy-harvesting transducer or channel for which a corresponding template or reference operating value can be defined. A modal node can correspond to a frequency-associated operating point, a power-associated operating point, a resonance mode, or another discrete state capable of recognition by the disclosed controller.

As used herein, a “template power” refers to a reference power value associated with a candidate modal node. In some embodiments, template power is predetermined from device characterization. In some embodiments, template power is derived from calibration. In some embodiments, template power is associated with a phi-spaced mode family for phi-native transducers. In some embodiments, template power is associated with a measured non-phi-native mode family.

As used herein, a “normalized power ratio” refers to a dimensionless ratio between a measured or computed power value and a template power value associated with a candidate modal node. In preferred embodiments, the normalized power ratio for candidate node k is expressed as x_k=P/P_k, where P is measured instantaneous or windowed power and P_k is the template power for candidate node k.

As used herein, “J-cost” refers to the cost kernel applied to a normalized power ratio to quantify deviation of an observed operating condition from a candidate modal node. In preferred embodiments, the J-cost kernel is expressed as J(x)=½(x+1/x)−1, where x is a normalized power ratio. For clarity and document portability, the same relationship may be presented in symbols, words, equivalent textual formatting, fixed-point form, floating-point form, lookup-table form, piecewise approximation, or other computational implementation that preserves the disclosed recognize-then-lock behavior and the same J-cost-based recognized-node selection logic. The controller does not use J-cost as a merely optional confidence score layered onto an otherwise conventional optimizer. Rather, deviation from a candidate modal node is quantified using J-cost over normalized power ratios, and recognized-node selection is driven by that evaluation, followed by retuning to lock operation to the recognized node.

As used herein, a “recognized node” refers to a candidate modal node selected by the controller according to the disclosed decision logic, including threshold comparison, ranking, and persistence logic where applicable. In preferred embodiments, if multiple candidate nodes satisfy the applicable threshold criterion, the recognized node is the node having the minimum J-cost.

As used herein, “phase-lock” refers to adjustment of one or more switching-control parameters so that harvested operation is aligned to a recognized node phase or equivalent target state.

Depending on embodiment, the controlled parameter or parameters can include duty cycle, switching phase, gate timing, source impedance selection, transfer timing, or combinations thereof.

As used herein, “E_coh” refers to a coherence quantum used in the preferred RS-native embodiments and equal to phi\hat{ }−5 in RS-native units. In the described embodiment, E_coh is approximately 0.090 eV and approximately 1.44×10\hat{ }−20 J. In preferred embodiments, E_coh is used as a transfer quantum and is also coupled to thresholding logic used for node recognition.

As used herein, “eight-tick synchronization” refers to alignment of selected controller activities to integer multiples of 8tau0. In the disclosed preferred RS-native architecture, the 8-tick period is the unique minimal ledger-compatible cycle and is used for classification cadence, gate-edge alignment, transfer release timing, or combinations thereof.

As used herein, “phi” (phi) refers to the golden ratio, i.e., (1+sqrt(5))/2. References to “phi\hat{ }−5” refer to phi raised to the power −5. For clarity and document portability, “phi\hat{ }−5” may also be written as “phi raised to the power −5” or “phi to the minus five,” and such textual forms are equivalent.

The exponent of phi in the coherence quantum E_coh=phi\hat{ }−5 is not chosen arbitrarily. In the disclosed RS-native description, the exponent is structurally forced by the relationship between the spatial dimension D and the minimal ledger-compatible period. With D=3, the minimal ledger-compatible period is 2\hat{ }D=8. The coherence exponent then equals (2\hat{ }D−D)=5, consistent with the Fibonacci identity F_6-F_4=F_5=5. The coherence quantum is therefore E_coh=phi raised to the power −(2\hat{ }D−D)=phi\hat{ }−5 in RS-native units. Machine-checked support for the value of the coherence exponent is identified in the referenced Lean modules, including coherence_exponent_eq_5 and D_3_fibonacci_constraint.

As used herein, “tau0” (tau00) refers to a base timing tick of a controller timing source or clock used to schedule controller activities. “8tau0 ” refers to an interval equal to eight tau0 ticks. The particular absolute duration of tau0 may depend on implementation (e.g., clock rate, timer resolution, or oscillator selection), and references to tau0 and 8tau0 provide a structural timing framework rather than requiring any specific absolute time unit unless expressly stated.

As used herein, inclusive comparison expressions such as “less than or equal to” may be written in symbols (e.g., “<=” or “<=”) or in words, and these are equivalent.

As used herein, indexed variables (e.g., x_k and P_k) indicate association with a candidate node identified by index k. For document portability, subscripts may be expressed as x(k) and P(k), and such forms are equivalent.

As used herein, “round(.)” refers to rounding a value to a nearest integer. A rounding tie policy (e.g., round-half-up or round-to-even) may be selected as an implementation choice in firmware or hardware. Unless expressly recited, the selection of a particular tie policy does not change the recognition-directed controller architecture described herein.

In the preferred RS-native description of the disclosed controller, the controller is designed within a framework in which the recognition-composition law is written as: J(xy)+J(x/y)=2J(x)J(y)+2J(x)+2J(y).

The J-cost function J(x)=½(x+1/x)−1 is, in the disclosed RS-native description, the unique cost function satisfying the recognition-composition law J(xy)+J(x/y)=2J(x)J(y)+2J(x)+2J(y). J is non-negative on the positive reals, vanishes if and only if x=1, and admits the local expansion J(1+epsilon)=epsilon\hat{ }2/2+O(epsilon\hat{ }3). Machine-checked support for these properties is identified by reference to the Lean modules Jcost_nonneg, Jcost_eq_zero_iff_one, and Jcost_one_plus_eps_quadratic.

For clarity and document portability, mathematical relationships in this specification may be presented using symbols, words, or a combination thereof. Unless expressly recited as a required limitation, such relationships are provided to explain controller operation and may be implemented using fixed-point arithmetic, floating-point arithmetic, lookup tables, piecewise approximations, or equivalent computational techniques that preserve the described recognize-then-lock behavior.

Under the stated recognition-composition requirements, the J-cost function J(x)=½(x+1/x)−1 is used as the cost kernel for classification. The controller uses that specific kernel because the classifier is not based on an arbitrary or heuristic score. Rather, in the disclosed architecture, deviation from a modal node is quantified using J-cost over normalized power ratios.

In the preferred RS-native architecture, the J-cost function J(x)=½(x+1/x)−1 is not merely a selected scoring function but is the unique cost function satisfying the stated recognition-composition requirements. Likewise, E_coh=phi\hat{ }−5 is presented as structurally forced in that framework, and the 8-tick cadence is presented as the unique minimal ledger-compatible cycle. The threshold phi\hat{ }−5 used for node recognition is not arbitrary and, in the preferred RS-native architecture, is coupled to the maximum J-cost that can be absorbed without creating a ledger deficit.

The disclosure may identify corresponding machine-checked support by reference to Lean modules including, by way of example, modules associated with Jcost_nonneg, Jcost_eq_zero_iff_one, Jcost_one_plus_eps_quadratic, coherence_exponent_eq_5, eight_tick_uniqueness, neutral_every_8th_from0, phi_forcing_principle, complete_forcing_chain, and ledger_neutral. In the preferred RS-native description, these modules provide machine-checked support for the exact J-cost properties, coherence exponent, eight-tick uniqueness, forcing-chain support, and ledger-neutral transfer relationships used in the disclosed controller architecture. Such references are included as technical support and credibility anchors and do not replace the structural and operational disclosure set forth herein.

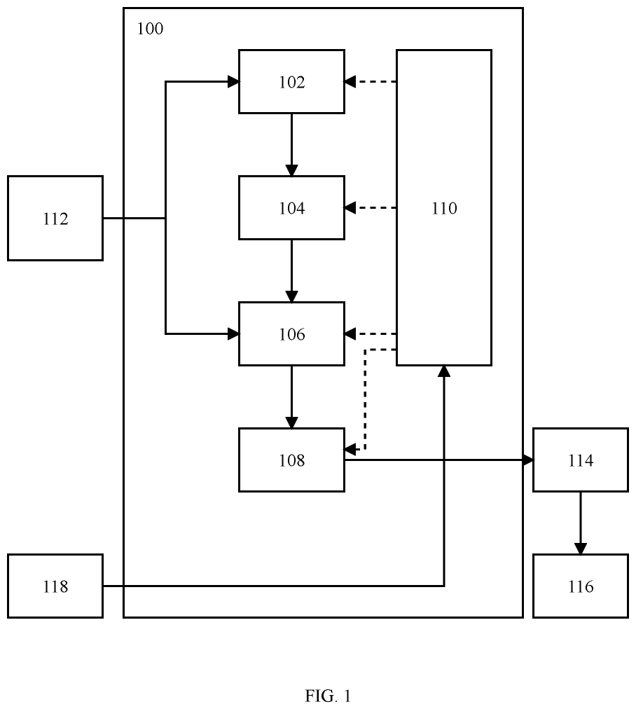

Referring generally to FIG. 1, a recognition-directed adaptive phase-locked energy-harvesting system controller 100 includes a recognition engine 102, an adaptive phase-locked loop 104, a multi-input power stage 106, an E_coh-locked transfer stage 108 in preferred embodiments, and a telemetry and failsafe subsystem 110. The controller 100 is coupled to one or more transducer inputs 112 and provides conditioned energy to a regulated output bus 114, which can feed a storage or load interface 116. In some embodiments, the controller further communicates through an optional communications link 118.

The transducer inputs 112 can be associated with one or more energy-harvesting transducers. In some embodiments, the transducers are all of one type. In preferred embodiments, the transducers are heterogeneous and can include piezoelectric, magnetostrictive, spin-Seebeck, NF-TPV, rectenna, thermoelectric, or other modal transducers. In multi-channel embodiments, each channel can be independently sensed, classified, and controlled while sharing a common recognition-directed controller framework.

A signal path is provided from the transducer inputs 112 to the recognition engine 102. A corresponding control path extends from the recognition engine 102 to the adaptive phase-locked loop 104 and from the adaptive phase-locked loop 104 to the power stage 106. In preferred embodiments, an additional transfer path extends from the power stage 106 to the E_coh-locked transfer stage 108 and then to the regulated output bus 114. The telemetry and failsafe subsystem 110 receives status information from the recognition engine 102, the adaptive phase-locked loop 104, the power stage 106, and the transfer stage 108, and can issue alerts, log controller state, publish telemetry, or place the controller into a safe operating mode.

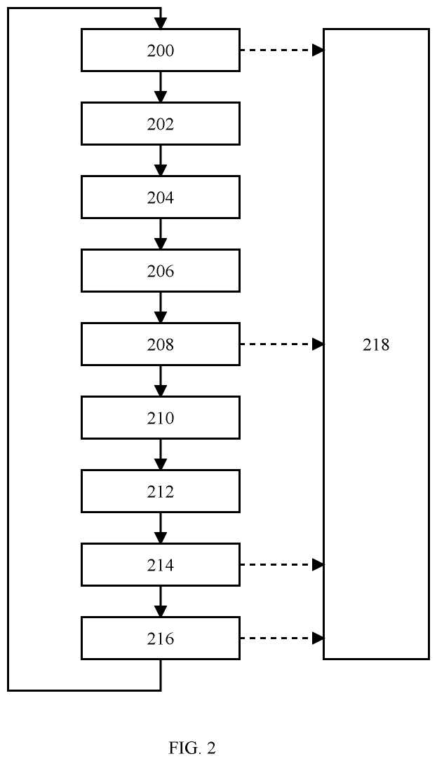

Referring generally to FIG. 2, the disclosed controller executes a workflow beginning with a sensing stage 200. In the sensing stage 200, the controller acquires electrical signals associated with one or more transducers. In preferred embodiments, these signals include voltage V and current I. In some embodiments, the controller also acquires or derives dV/dt and dI/dt. In some embodiments, the controller further receives temperature, vibration, emitter condition, channel identifier, calibration data, prior recognized-node state, or other state metadata.

The sensed signals are processed in a preprocessing stage 202. In preferred embodiments, preprocessing includes determination of instantaneous power according to P=V×I. In some embodiments, preprocessing further includes filtering, averaging, windowing, normalization, scaling correction, offset correction, or channel-specific compensation. The output of preprocessing is a measured or computed power value suitable for comparison against modal-node templates.

In a template retrieval stage 204, the controller identifies candidate modal-node templates for comparison. In some embodiments, templates are retrieved from memory and correspond to known resonance states or operating modes. In some embodiments, templates are generated from factory calibration data. In preferred embodiments, phi-native transducers use phi-spaced template powers and or frequencies. In further embodiments, non-phi-native transducers use calibration-derived templates.

In a normalized ratio computation stage 206, the controller forms normalized power ratios for the candidate modal nodes. In preferred embodiments, the normalized power ratio for candidate node k is x_k=P/P_k. In a J-cost evaluation stage 208, the controller evaluates J(x_k)=½(x_k+1/x_k)−1 for each candidate node. In some embodiments, this evaluation is performed sequentially. In some embodiments, this evaluation is performed in parallel across a hardware compute array or equivalent accelerator.

In a threshold and ranking stage 210, the controller compares the evaluated J-cost values to a threshold criterion and ranks the candidate nodes. In preferred embodiments, a node qualifies when J(x_k)<=J_threshold. In preferred RS-native embodiments, J_threshold=phi\hat{ }−5. That threshold is not arbitrary and, in the disclosed RS-native architecture, corresponds to E_coh and to the maximum J-cost that can be absorbed without creating a ledger deficit. If multiple nodes satisfy the threshold criterion, the controller selects the node having the minimum J-cost. If no node satisfies the threshold criterion, the controller can retain the previous node, enter a search mode, request recalibration, widen or narrow the template search, or fall back to a safe operating mode.

In a node selection stage 212, the controller identifies a recognized node. In preferred embodiments, recognition is not asserted on the basis of a single qualifying sample alone. Rather, the controller uses a persistence rule so that recognized-node selection reflects a stable modal determination rather than a transient fluctuation. In preferred eight-tick embodiments, a recognized-node decision is confirmed only after two consecutive qualifying samples aligned to 8tau0 boundaries. In some embodiments, the controller further applies hysteresis, debounce timing, a minimum-separation criterion between the best and next-best candidate, or a confidence band. This persistence-based recognized-node decision is part of the disclosed recognition architecture and helps distinguish the controller from systems that merely compute a score and immediately retune on a single sample.

Once a recognized node is selected, the controller proceeds to a PLL retune stage 214. In this stage, the adaptive phase-locked loop adjusts one or more switching-control parameters so that harvested operation is locked to the recognized node. In some embodiments, the adjusted parameter is duty cycle. In some embodiments, the adjusted parameter is source impedance. In some embodiments, the adjusted parameter is switching phase, gate timing, transfer release timing, or combinations thereof. The retuning stage can be repeated channel by channel in a multi-channel controller.

In preferred embodiments, a transfer gating stage 216 follows or operates concurrently with PLL retuning. In such embodiments, harvested energy is not immediately released to the output bus in arbitrary increments. Instead, energy release is governed by the preferred E_coh-locked transfer discipline described below. In preferred timing embodiments, release is further aligned to an allowed 8tau0 boundary.

A telemetry and fault-handling stage 218 operates continuously or periodically throughout the workflow. In this stage, controller status, node selections, J-cost values, duty cycle, impedance rung, transfer count, efficiency, and other data can be logged or transmitted. The controller can also monitor latency, lock state, accumulator status, and other fault conditions and can enter a safe operating mode when applicable fault criteria are met.

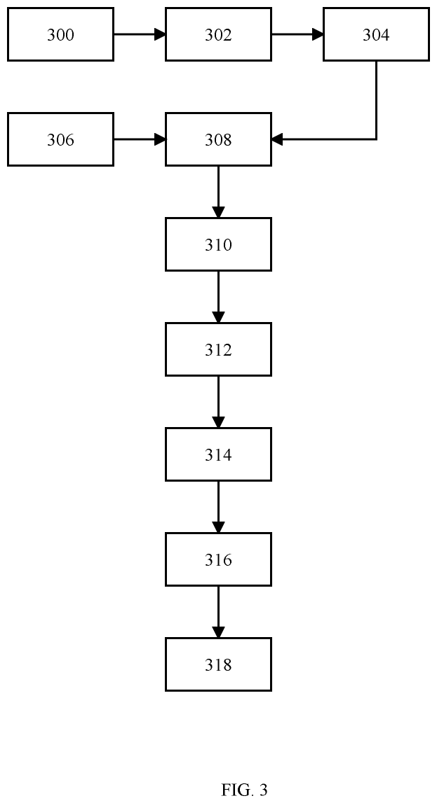

Referring generally to FIG. 3, the recognition engine receives electrical inputs through a sensor input interface 300, computes power in a power calculator 302, generates one or more features in a feature-vector generator 304, accesses candidate modal-node templates in modal template memory 306, forms normalized power ratios in a ratio engine 308, evaluates J-cost in a J-cost compute pipeline 310, compares the resulting values against threshold in a threshold comparator 312, selects a lowest-cost qualifying candidate in an argmin selector 314, applies persistence and debounce logic in block 316, and stores or outputs recognized-node information through a node output register 318.

In some embodiments, the recognition engine is implemented primarily in hardware. In some embodiments, the recognition engine includes a hardware accelerator or compute array. In some embodiments, supervisory logic is executed by a microcontroller, processor, FPGA logic, ASIC logic, or a mixed hardware-software combination. The exact implementation can vary, but the disclosed scoring logic remains anchored to the normalized power ratio and J-cost evaluation sequence.

In preferred embodiments, the recognition engine operates on an input vector including at least [V, I, dV/dt, dI/dt]. In some embodiments, additional sensed features are included. The scoring logic can therefore be implemented as a concrete processing sequence in which instantaneous power is determined, normalized ratios are formed, J-cost values are computed, candidate modal nodes are ranked, and a recognized node is selected for retuning. In some embodiments, the controller outputs a recognized node index, a best J-cost value, and optionally a ranked candidate list, confidence score, or retune request.

In preferred embodiments, the template library includes phi-spaced template sets for phi-native transducers and calibration-derived template sets for non-phi-native transducers. In some embodiments, calibration occurs at manufacture. In some embodiments, calibration is performed in the field. In some embodiments, updated template values can be stored in memory. The disclosure is strongest on concrete template-based recognition rather than wholly unspecified adaptive template generation.

In one demonstrated implementation, the recognition engine includes a hardware evaluation pipeline and supervisory processing resources configured to support rapid modal classification. Example implementation details described in the source materials include a 512-cell compute array, supervisory logic implemented using a processor such as a 240 MHz ARM Cortex-M7 with floating-point support, and channel sensing using an 18-bit delta-sigma converter at approximately 1 Msample/s per channel. These details are provided as implementation examples for make-and-use support and are not required unless expressly recited.

In some implementations, the recognition engine, the adaptive phase-locked loop, the E_coh-locked transfer stage, and the telemetry and failsafe subsystem are implemented by a processor coupled to a memory and to a hardware compute array, where the memory stores instructions that, when executed by the processor, cause the controller to perform J-cost evaluation over normalized power ratios, integer-N E_coh-locked transfer gating, and 8tau0 edge alignment as described herein. The compute array is configured to evaluate J(x_k) in parallel across the candidate modal nodes, and the supervisory processor is configured to apply persistence, rank-by-minimum, and PLL retune control as described herein.

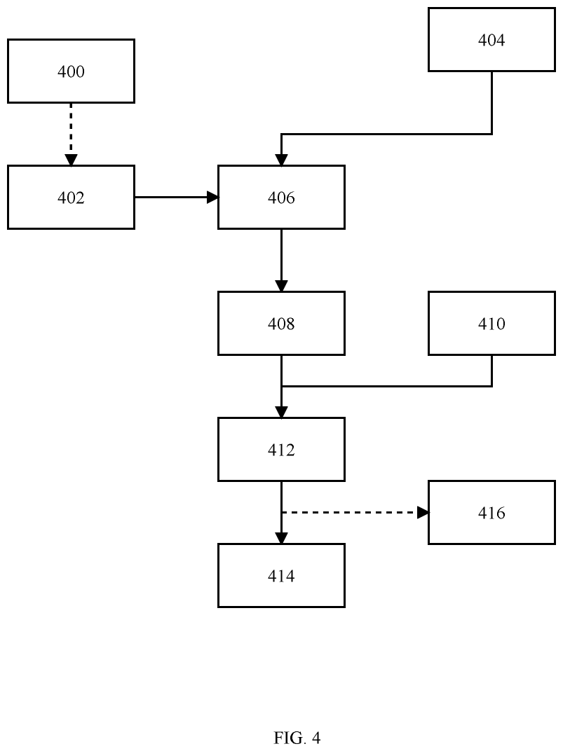

Referring generally to FIG. 4, the controller evaluates a candidate node set 400 in relation to corresponding template powers 402 and a measured power value 404 obtained from the transducer input. For each candidate node, the controller forms a normalized power ratio 406, preferably according to x_k=P/P_k, where P is the measured or computed power associated with present transducer operation and P_k is the template power associated with candidate node k. The controller then computes a corresponding J-cost value 408 for each candidate node using J(x_k)=½(x_k+1/x_k)−1.

FIG. 4 further illustrates a threshold level 410, a qualifying node subset 412, and a winning node 414 selected from the candidate node set. In preferred embodiments, a candidate node is treated as qualifying when its corresponding J-cost satisfies J(x_k)<=J_threshold. In preferred RS-native embodiments, J_threshold=phi\hat{ }−5, and that threshold is not arbitrary. If multiple candidate nodes satisfy the threshold condition, the controller selects the winning node 414 according to an argmin rule, namely the qualifying node having minimum J-cost. In some embodiments, the controller further generates an optional confidence metric 416, which can reflect margin relative to threshold, separation from the next-best candidate, persistence across consecutive samples, or a combination thereof.

Accordingly, FIG. 4 illustrates the relationship between candidate modal nodes, template powers, normalized ratios, J-cost evaluation, threshold qualification, and minimum-cost node selection in the disclosed recognition architecture.

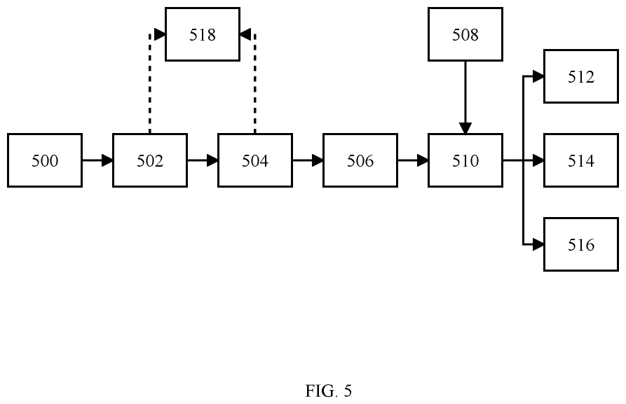

Referring generally to FIG. 5, an adaptive phase-locked loop receives a recognized-node input 500 and generates control outputs that retune the switching power stage to the recognized node. In the illustrated embodiment, the loop includes a phase detector 502, a loop filter 504, a control-law block 506, a timing source 508, and an edge-alignment stage 510. The loop produces one or more control outputs, including a switch-drive output 512, a duty-cycle control output 514, and an impedance-selection output 516. In some embodiments, the loop further includes a phase-error monitor 518 or equivalent supervisory logic.

The purpose of the adaptive phase-locked loop is not merely to regulate output power in a generic sense, but to lock harvested operation to the recognized modal node identified by the recognition engine. In some embodiments, the loop aligns a harvested phase variable to a recognized node phase. In some embodiments, the loop drives the converter toward a recognized modal operating condition by coordinated adjustment of duty cycle, switching phase, impedance rung, gate timing, transfer timing, or related switching events. The disclosed loop therefore operates as a node-directed retuning mechanism rather than as a free-running closed-loop regulator. The recognition engine and the adaptive phase-locked loop accordingly operate as a coupled recognize-then-lock control architecture in which recognition determines the retuning target and the loop executes retuning toward that recognized modal condition.

In preferred embodiments, the control-law block 506 uses phi-derived coefficients. More particularly, in the disclosed preferred implementation, K_p=1/phi, K_i=phi\hat{ }2, and K_d=phi\hat{ }−5. These are not arbitrary tuning constants in the disclosed architecture. Rather, they are disclosed as phi-ratio-derived coefficients used in the preferred RS-native implementation of the loop.

In one demonstrated implementation, the adaptive phase-locked loop includes a time-to-digital phase detector, a digital control-law stage, and timing-generation logic configured to retune a switching power stage within a reported transient interval substantially shorter than a legacy MPPT comparator. Example reported loop characteristics include approximately 56 degrees phase margin, approximately 8 dB gain margin, and approximately 13 milliseconds settling for a substantial node shift. These values are disclosed as demonstrated implementation characteristics and not as mandatory limitations for all embodiments.

The timing source 508 can be implemented as a voltage-controlled oscillator, digitally controlled timing source, numerically controlled oscillator, timer block, clocked state machine, or equivalent timing generator. The resulting timing signal is supplied to the edge-alignment stage 510. In preferred eight-tick embodiments, gate-drive edges are aligned according to the relationship: t_edge=round(t_PLL/(8tau0))×8tau0.

In preferred embodiments, the edge-alignment stage 510 selects the nearest allowable 8tau0 boundary while keeping phase error acceptably low relative to the recognized node.

The outputs of the adaptive phase-locked loop can control one or more operating parameters of the power stage. In some embodiments, the loop updates duty cycle only. In some embodiments, the loop updates source impedance selection only. In some embodiments, the loop updates both duty cycle and impedance selection. In some embodiments, the loop additionally controls switching phase or transfer timing. The controller can therefore implement phase-locked retuning at multiple control layers while preserving the recognize-then-lock architecture.

In demonstrated embodiments, the adaptive phase-locked loop exhibits example performance including a phase margin, gain margin, settling time, and bounded steady-state phase error. Such values are example performance values for disclosed embodiments rather than mandatory limits for all embodiments.

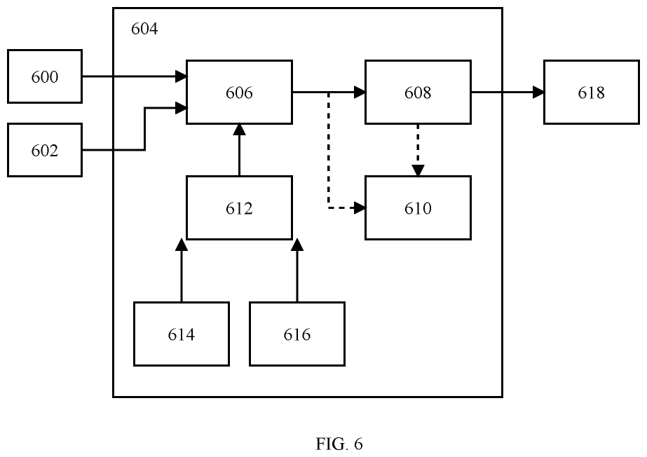

Referring generally to FIG. 6, the multi-input power stage includes one or more transducer channel inputs, such as first and second transducer channel inputs 600 and 602, feeding a synchronous converter stage 604. The synchronous converter stage 604 includes switching devices 606, one or more channel energy storage elements 608, a sense path 610, an impedance network 612, a phi-ladder rung selector 614, a fine-control block 616, and a channel output combiner 618. In preferred embodiments, the converter topology is a synchronous buck-boost topology.

In one demonstrated implementation, the multi-input power stage includes synchronous switching half-bridges implemented using GaN devices, with example rise times on the order of a few nanoseconds, example channel current capability on the order of 8 A per channel, and an example bus voltage on the order of 48 V. These values are disclosed as implementation examples supporting the described embodiments and are not required unless expressly recited.

Each channel can be independently coupled to a transducer and independently controlled. In some embodiments, each channel includes its own sensing path, switching devices, energy storage element, and impedance network. In some embodiments, at least some channel resources are shared while the control variables remain logically distinct. The important point for the present disclosure is that each channel remains independently classifiable and retunable according to its recognized modal node.

In preferred embodiments, source impedance is programmable on a phi-ladder according to: Z_n=Z_0×phi\hat{ }n,

for integer n. In the described preferred embodiment, an example range extends from n=−5 to n=+5. Example corresponding impedance values can extend from approximately 0.09 ohms at the lower end to approximately 11.1 ohms at the upper end for Z_0=1.00 ohm. The phi-ladder arrangement provides a structured impedance-selection framework for node-directed retuning. In the source materials, adjacent rungs are associated with a single-rung coherence cost J(phi)=phi−3/2, and that relationship may be preserved in the preferred RS-native description.

Within a selected impedance rung, fine control can be achieved by pulse-width modulation or another continuous control mechanism. Thus, the controller can combine discrete rung selection with continuous within-rung refinement. This layered control approach provides a practical way to couple discrete modal recognition to physical converter actuation without requiring infinitely fine discrete impedance states.

The cost of a single-rung phi-ladder transition is J(phi)=phi−3/2, which is the minimum coherence cost associated with a single-rung change in source impedance Z_n to Z_{n+1} or Z_n to Z_{n−1}. Successive single-rung adjustments therefore incur the smallest possible coherence cost per step, in contrast to large multi-rung jumps. In preferred embodiments, the controller applies single-rung adjustments preferentially, with within-rung fine control achieved by pulse-width modulation.

The power stage outputs can include one or more regulated power packets or channel outputs, a selected duty-cycle value, a selected impedance rung, channel status data, and an output-bus feed. Those outputs can be used internally by the transfer stage and externally by the telemetry subsystem.

If alternative converter topologies are mentioned, they are subordinate variations that preserve the same recognize-then-lock control law and the same node-directed retuning logic. The identity of the invention remains the controller architecture rather than the bare converter topology.

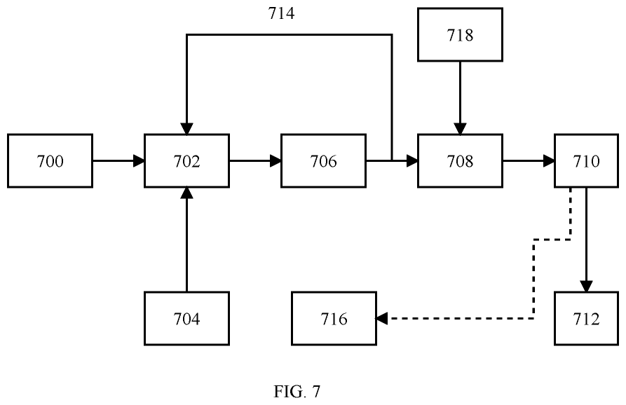

Referring generally to FIG. 7, the E_coh-locked transfer stage receives channel energy at input 700 and includes an accumulator 702, an accumulator least-significant-bit reference 704, an integer threshold detector 706, transfer-enable logic 708, a transfer switch 710, an output-bus coupling 712, a remainder recirculation path 714, a transfer counter 716, and, in some embodiments, a bus-ready or fault gate 718.

In preferred embodiments, E_coh=phi\hat{ }−5 is used as the transfer quantum and energy is transferred only in integer multiples thereof. In the preferred RS-native description, the use of E_coh=phi\hat{ }−5 as the transfer quantum is not an arbitrary quantization choice. Rather, the transfer stage is configured so that released energy corresponds to integer multiples of the coherence quantum and so that sub-threshold remainder energy is retained rather than discarded or continuously released. This relationship supports the disclosed ledger-neutral transfer discipline.

In operation, incoming harvested energy is accumulated in accumulator 702. In preferred embodiments, the least significant bit of accumulator 702 corresponds to E_coh. The integer threshold detector 706 determines when accumulated energy reaches or exceeds an integer threshold N×E_coh. When the threshold condition is met, transfer-enable logic 708 authorizes a transfer event, subject in some embodiments to additional gating conditions such as timing alignment, output-bus readiness, or no-fault status. The transfer switch 710 then couples stored energy to the output bus through coupling 712. Any remainder below the next integer multiple is retained through recirculation path 714 for a later cycle rather than being discarded or released as a fractional transfer. In the disclosed architecture, this integer-multiple transfer discipline is not merely a convenience for digital accounting but part of the preferred controller operation by which released energy is constrained to integer multiples of the coherence quantum and sub-threshold remainder is preserved for later compliant release.

In preferred embodiments, the acceptance criteria for a transfer event include:
(a) E_acc>=N×E_coh,
(b) optional 8tau0 alignment,
(c) optional bus-ready condition, and
(d) optional no-fault condition.

In some embodiments, transfer count information is incremented and published through telemetry after each transfer event.

In the preferred RS-native description, integer-multiple transfer is associated with ledger neutrality, which can be represented in plain text as: DeltaC=N×E_coh−N×E_coh=0.

This is a preferred technical effect statement of the disclosed transfer discipline.

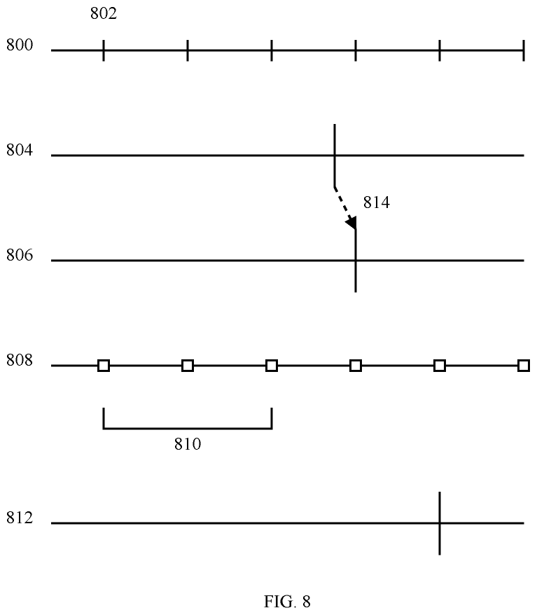

Referring generally to FIG. 8, the controller can implement an eight-tick synchronization discipline across multiple stages of operation. In the preferred RS-native architecture, the 8-tick period is the unique minimal ledger-compatible cycle. In preferred embodiments, the controller aligns classification cadence, gate-drive edge timing, and transfer release timing to integer multiples of 8tau0. In the preferred RS-native description, this cadence is not merely a convenient timing grid. Rather, the 8-tick period is presented as the unique minimal ledger-compatible cycle, and its use in classification cadence, edge alignment, and transfer release provides the preferred timing discipline for the disclosed controller architecture.

A macro switching period 800 can be divided into permitted 8tau0 slot boundaries 802. A raw PLL edge timing estimate 804 is mapped to a snapped gate-edge timing 806 at one of the permitted boundaries. Classification sample points 808 can be similarly aligned to 8tau0 boundaries, and a consecutive-qualifier window 810 can require repeated qualifying classifier outputs before a node-recognition decision is finalized. In preferred embodiments, transfer release occurs at a transfer-release boundary 812 that also corresponds to an allowed 8tau0-aligned event. A phase-error-minimization selection 814 can be used to select among permitted boundaries while preserving node-lock performance.

In narrower embodiments, the controller can independently employ one or more of:
(a) edge-snapping to an 8tau0 boundary,
(b) requiring two consecutive aligned classifier outputs before recognition is finalized, and
(c) releasing accumulated energy only at a permitted 8tau0 boundary.

Even in such narrower embodiments, the disclosed architecture preserves the relationship between recognized-node decision logic and timing discipline by using 8tau0-aligned events as part of classification, retuning, transfer release, or combinations thereof. Accordingly, eight-tick synchronization should be understood as a structural timing discipline of the preferred controller architecture rather than as a merely decorative timing convention.

The 8-tick period 8tau0 is, in the disclosed RS-native description, the unique minimal ledger-compatible cycle: any cycle of period less than 2\hat{ }D=8 fails to cover the recognition state space for D=3, and any longer cycle is not minimal. Energy transfers and gate-drive edges aligned to 8tau0 boundaries therefore preserve ledger neutrality across each complete 8-tick window.

Machine-checked support for the uniqueness of the 8-tick period and for the neutrality of every complete 8-tick window is identified by reference to the Lean modules eight_tick_uniqueness and neutral_every_8th_from0.

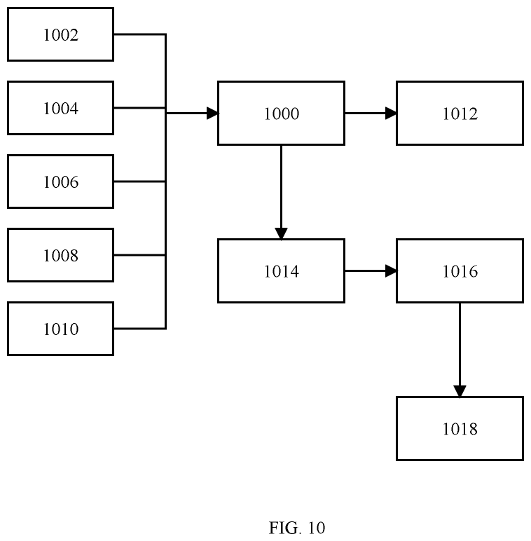

Referring generally to FIG. 10, the controller can include a telemetry, watchdog, and failsafe subsystem having a status-input aggregator 1000, a node-index register 1002, a J-cost register 1004, a duty-and-impedance status block 1006, a transfer-count register 1008, an efficiency estimator 1010, a telemetry formatter 1012, watchdog logic 1014, a fault detector 1016, and a safe-mode controller 1018.

Telemetry outputs can include one or more of:
V_in,
I_in,
   recognized node index, J-cost, duty cycle, impedance rung, E_coh transfer count, efficiency, alert flags, status words, or other state data.

The telemetry formatter 1012 can generate local logs, wired packets, wireless messages, supervisory control messages, or other reporting outputs. In some embodiments, telemetry is published at a fixed rate. In some embodiments, telemetry is event-driven. The exact telemetry format and transport remain optional. In one demonstrated implementation, telemetry is published in a structured data format at a periodic update rate, for example approximately 100 Hz, and includes values such as input voltage, input current, recognized node index, J-cost, duty cycle, impedance rung, E_coh transfer count, and efficiency. Such telemetry arrangements are implementation examples and are not required unless expressly recited.

The watchdog and fault-detection logic can monitor for controller conditions requiring intervention. In preferred embodiments, example triggers include:

(a) recognition latency greater than 10 microseconds, (b) PLL unlock lasting longer than 2 milliseconds, and(c) accumulator overflow.

When a trigger condition is satisfied, safe-mode controller 1018 can place the controller into a safe constant-voltage mode or another safe operating mode. This fallback behavior illustrates that the disclosed controller is a real implemented system and not a purely conceptual classification framework.

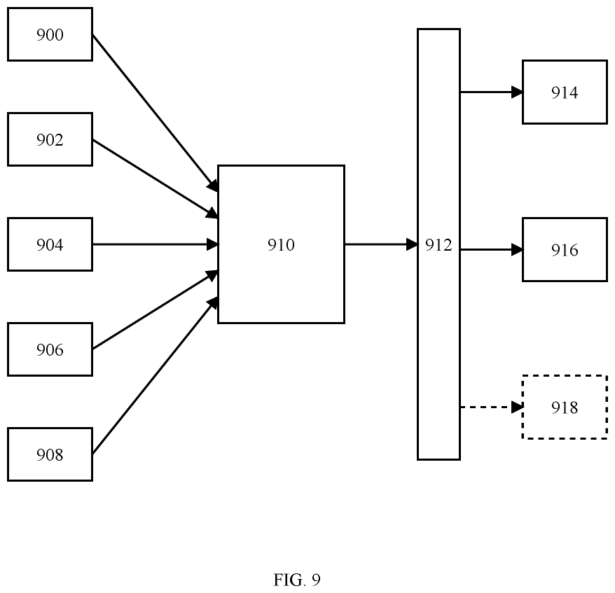

Referring generally to FIG. 9, the disclosed controller can be used with heterogeneous transducer types, including, by way of example, piezoelectric transducers 900, magnetostrictive transducers 902, spin-Seebeck transducers 904, NF-TPV transducers 906, and rectenna transducers 908 coupled to a controller 910. Controller 910 can supply conditioned power to a shared or segmented output bus 912, which can feed a storage device 914, a load device 916, and, in some embodiments, an optional powered module 918.

Different channels can use different template libraries, different impedance settings, and different retuning histories while remaining under common control logic. In preferred embodiments, phi-native transducers use phi-spaced template powers and or frequencies, while non-phi-native transducers use calibration-derived templates.

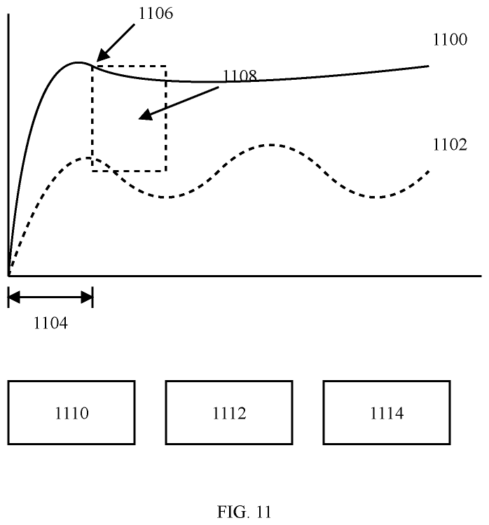

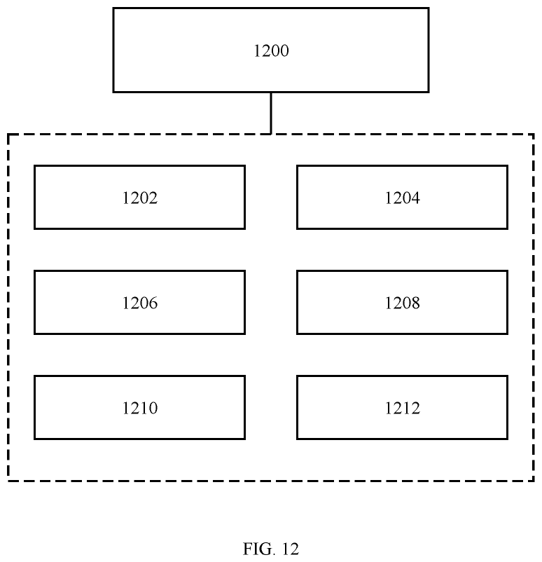

Referring generally to FIG. 11 and FIG. 12, the disclosure can include demonstrated example data for benchmark, transient, reliability, EMC, and related validation purposes. In one demonstrated embodiment, a mixed-source bench configuration includes spin-Seebeck, NF-TPV, piezoelectric, and rectenna sources. Under reported example conditions, the recognition-directed adaptive phase-locked controller produces approximately 4.80 W as compared to approximately 4.04 W for a legacy MPPT comparator under a mixed-source bench configuration, corresponding to an improvement on the order of approximately 19 percent. The source materials further report example transient behavior including settling on the order of approximately 13 milliseconds for the disclosed controller as compared to approximately 120 milliseconds for the legacy comparator, together with reduced overshoot and reduced transient energy loss. These values are validation evidence for demonstrated embodiments and not universal guarantees.

Referring to FIG. 11, the performance comparison diagram 1100 includes an RD-PLL output trace 1102 and an MPPT output trace 1104, together with a settling-time interval indicator 1106, an overshoot comparison indicator 1108, a transient energy-loss comparison indicator 1110, and one or more summary indicators including steady-state efficiency summary 1112 and phase-accuracy and/or latency summary 1114.

Referring to FIG. 12, the validation and measured-results summary 1200 includes a mixed-source bench configuration representation 1202, per-channel J-cost results 1204, a burn-in summary 1206, an EMC summary 1208, a timing-alignment summary 1210, and a transfer-quantization and/or implementation-support summary 1212.

In demonstrated embodiments, the improvement mechanism is attributed to rapid node classification followed by immediate lock-to-node retuning, thereby reducing transient loss that can arise when a conventional MPPT controller hill-climbs through suboptimal operating points. In one demonstrated steady-state operating condition, reported example J-cost values for respective channels include values on the order of 0.0012 for a piezoelectric channel, 0.0008 for a spin-Seebeck channel, 0.0021 for an NF-TPV channel, and 0.0015 for a rectenna channel, all below the preferred threshold phi\hat{ }−5. These reported values provide concrete validation support for the disclosed recognition and lock-control architecture.

In one demonstrated embodiment, the source materials report an example efficiency breakdown including conduction loss, switching loss, digital overhead, and sensing or telemetry overhead, resulting in overall conversion efficiency on the order of approximately 96 percent at approximately 4.8 W aggregate input. Such values are included as demonstrated validation support for the disclosed architecture.

The disclosure can further identify demonstrated reliability and EMC data, including a reported burn-in interval of approximately 120 hours at approximately 85 C with zero node misclassifications, low efficiency drift, and small variation in J-cost, together with reported compliance with CISPR-25 class 3 emissions requirements with stated margin. In the source materials, the preferred eight-tick alignment is also described as contributing to EMC performance by concentrating switching energy according to the preferred cadence rather than spreading it across arbitrary frequencies. These results are validation evidence for disclosed embodiments rather than universal guarantees for all implementations.

The specification can also cross-reference the machine-checked support identified above, including modules associated with J-cost properties, coherence exponent, eight-tick uniqueness, and ledger neutrality. These references add technical credibility and preserve support around exact derivation, exact thresholds, and structural support for the preferred RS-native embodiments.

Alternative embodiments should remain subordinate and should not blur the identity of the invention. Appropriate alternatives include one or more channels, different digital or mixed-signal implementations, different template storage arrangements, different converter topologies that preserve node-directed retuning, and different telemetry or supervisory arrangements, provided the recognize-then-lock control kernel remains intact. Alternatives that would undercut the disclosed architecture, such as treating omission of recognized-node-based retuning, omission of the J-cost-driven recognition kernel, omission of E_coh-linked transfer discipline, or omission of eight-tick synchronization as co-equal embodiments of the preferred system, should not be emphasized in the detailed description.

Downstream applications can be identified separately and subordinately, including industrial sensing, spacecraft housekeeping power, wearables or textiles, structural monitoring, agriculture, EV energy recovery, military remote power, wireless-module support, and quantum-adjacent support. Non-demonstrated deployments should be identified as illustrative or prophetic and should not be allowed to redefine the invention.

What is claimed is:

1. A power-management controller for an energy-harvesting system, comprising: a recognition engine configured to receive real-time electrical signals from at least one energy-harvesting transducer, determine a measured power value from the electrical signals, form normalized power ratios relative to a plurality of candidate modal-node template powers, and evaluate a J-cost function J(x)=½(x+1/x)−1 for the normalized power ratios to identify a recognized modal node; and a control circuit comprising a phase-locked loop configured to adjust at least one switching power-stage parameter to lock harvested operation to the recognized modal node.

2. The controller of claim 1, wherein the normalized power ratio for a candidate modal node k is x_k=P/P_k, where P is the measured power value and P_k is a template power associated with candidate modal node k.

3. The controller of claim 1, wherein the recognition engine is configured to identify the recognized modal node by selecting, from among qualifying candidate modal nodes, a candidate modal node having a minimum J-cost value.

4. The controller of claim 1, wherein a candidate modal node qualifies when its corresponding J-cost value satisfies J(x_k)<=J_threshold, and wherein J_threshold=phi\hat{ }−5.

5. The controller of claim 1, wherein the recognition engine is configured to classify the candidate modal nodes within 5 microseconds of waveform sampling.

6. The controller of claim 1, wherein the recognition engine is configured to confirm the recognized modal node only after at least two consecutive qualifying samples aligned to 8tau0 boundaries.

7. The controller of claim 1, wherein the phase-locked loop is configured with coefficients K_p=1/phi, K_i=phi\hat{ }2, and K_d=phi\hat{ }−5.

8. The controller of claim 1, wherein the phase-locked loop is configured to align a gate-drive edge according to: t_edge=round(t_PLL/(8tau0))×8tau0.

9. The controller of claim 1, further comprising a transfer stage configured to transfer harvested energy only in integer multiples of E_coh=phi\hat{ }−5.

10. The controller of claim 9, wherein the transfer stage comprises: an energy accumulator; an integer threshold detector configured to determine when accumulated energy reaches or exceeds N×E_coh; a gated transfer switch; and a remainder recirculation path configured to retain energy below a next integer multiple for a later cycle.

11. The controller of claim 10, wherein a least significant bit of the energy accumulator corresponds to E_coh, and wherein the transfer stage is configured to release harvested energy only at a permitted 8tau0 boundary.

12. The controller of claim 1, wherein the controller is configured to control at least four channels associated with heterogeneous transducer types selected from piezoelectric, magnetostrictive, spin-Seebeck, near-field thermophotovoltaic, rectenna, and thermoelectric transducers.

13. The controller of claim 12, wherein source impedance for each channel is programmable according to Z_n=Z_0×phi\hat{ }n for integer n ranging from −5 to +5.

14. The controller of claim 1, wherein the recognition engine operates on an input vector including at least voltage, current, and respective time derivatives [V, I, dV/dt, dI/dt].

15. A method of operating an energy-harvesting system, comprising: receiving real-time electrical signals from at least one energy-harvesting transducer; determining a measured power value from the electrical signals; forming normalized power ratios relative to a plurality of candidate modal-node template powers; evaluating, for the candidate modal nodes, a J-cost function J(x)=½(x+1/x)−1; identifying a recognized modal node according to resulting J-cost values; and adjusting at least one switching power-stage parameter using a phase-locked loop to lock harvested operation to the recognized modal node.

16. The method of claim 15, wherein identifying the recognized modal node comprises: qualifying candidate modal nodes whose corresponding J-cost values satisfy J(x_k)<=phi\hat{ }−5; and selecting, from among the qualifying candidate modal nodes, a candidate modal node having minimum J-cost value.

17. The method of claim 15, further comprising confirming the recognized modal node only after at least two consecutive qualifying samples aligned to 8tau0 boundaries, and transferring harvested energy only in integer multiples of E_coh=phi\hat{ }−5.

18. The method of claim 17, further comprising: accumulating harvested energy in an accumulator; detecting when accumulated energy reaches or exceeds N×E_coh; enabling a transfer event in response to the detecting; and retaining a remainder below a next integer multiple for a later cycle.

19. An energy-harvesting system, comprising: at least one energy-harvesting transducer; and the power-management controller of claim 1 coupled to the at least one energy-harvesting transducer.

20. The energy-harvesting system of claim 19, wherein the controller further comprises a telemetry and failsafe subsystem configured to output one or more of a recognized node index, a J-cost value, a duty cycle, an impedance rung, an E_coh transfer count, and an efficiency value, and to place the controller in a safe constant-voltage mode responsive to a fault condition including recognition latency greater than 10 microseconds, phase-locked-loop unlock lasting longer than 2 milliseconds, or accumulator overflow.
